(19) United States
(12) Patent Application Publication
(10) Pub. No.: US 2006/0171845 A1
(43) Pub. Date: Aug. 3, 2006

(54) Sensors for measuring analytes

(75) Inventors: Travis L. Martin, Fargo, ND (US); Daniel S. Engebretson, Sioux Falls, SD (US)

Correspondence Address: DORSEY & WHITNEY LLP;INTELLECTUAL PROPERTY DEPARTMENT, 50 SOUTH SIXTH STREET, MINNEAPOLIS, MN, 55402-1498, US

(73) Assignee: Dakota Technologies, Inc.

(21) Appl. No.: 11/342,762

(22) Filed: Jan. 30, 2006

Related U.S. Application Data
(60) Provisional application No. 60/648,977, filed on Jan. 31, 2005.

(51) Int. Cl. G01N 21/00

(52) U.S. Cl. 422/82.07

(57) ABSTRACT

A sensor and system using the sensor for detecting an analyte, where the sensor includes an amorphous fluorinated polymer and a luminescent metal-ligand complex is provided. Sensor systems for monitoring oxygen in environments containing volatile organic solvents are also provided.

### TECHNICAL FIELD

This invention relates to sensors, and more particularly to oxygen sensors and methods for their use.

### INTRODUCTION

Many sensors used for detecting an analyte of interest are based on a luminescent molecule or dye, typically embedded in a polymer matrix permeable to the analyte, that changes its luminescence properties upon interaction with the analyte. However, in many applications there are components within the samples being monitored that are soluble in the sensor membrane matrix, which change the luminescent molecules' response to the analyte. For instance, competitive quenching may occur when components other than the analyte diffuse into the polymer matrix and change the luminescent molecules' emission properties. If these components' concentrations vary with time, obtaining accurate analyte concentration values are difficult, if not impossible, to obtain. In addition, variations in environmental factors, such as temperature and pressure can further create inaccuracies in analyte detection by their effects on the luminescent dye properties.

An example of this situation is encountered in the environment of aircraft fuel tanks. Knowledge of oxygen levels in aircraft fuel tanks is important because oxygen concentrations greater than 8% form an explosive mixture with fuel vapors. It is estimated that 35% of the time, center-wing tanks have the right combination of heat, fuel vapor, and oxygen to explode, and only need a small spark to cause the explosion to occur. Use of oxygen sensors could reduce the risk of catastrophic accidents from fuel tank explosions by alerting a dangerous level of oxygen, which can be remedied by purging the tank with an inert gas, thereby reducing the oxygen level in the fuel to safer levels. Accurate measurement of oxygen, however, is complicated by the significant variations in temperature and pressure experienced by the aircraft, and by differences in the composition of aviation fuel, which can vary depending on fuel source. Oxygen sensors currently available include electrolytic cells and luminescent probes. Electrolytic cells present explosion hazards, thus requiring complex systems to isolate the sensor from the fuel tank to minimize the hazard. Currently available luminescent molecule based sensors are subject to physical or chemical degradation when exposed to volatile organic solvents (VOCs) present in aviation fuel, thus subjecting the dye molecule to interference by contaminants in the fuel composition and also degrading the performance of the sensor over time.

Thus, there is a need in the art for sensors that provide accurate measurement of analytes under varying environmental conditions and variations in sample components.

### SUMMARY

The disclosure provides a sensor for detecting and measuring presence of an analyte, where the sensor is chemically resistant to a variety of solvents, has high sensitivity to certain analytes, and can be processed to exclude components that would interfere with analyte measurement. The sensors disclosed herein comprise an amorphous fluoropolymer and a metal-ligand complex, where luminescence of the metal-ligand complex is altered by interaction with the analyte(s). Analytes access the luminescent molecule by diffusing through the pores of the polymer matrix.

In some embodiments, the ligand in the metal-ligand complex is a macrocycle that binds and chelates the metal. Macrocycles, such as porphyrins that have been fluorinated to enhance solubility in the solvents used to introduce the metal-ligand into the polymer matrix, are found to be incorporated into the polymer matrix when exposed to the solvent-dye mixture. Once trapped within the polymer, the metal-ligand complexes are stably held within the polymer over long periods of time and show large Stokes shifts. In addition, the polymers may be processed to change the average pore size of the polymer matrix, thereby allowing formation of sensors that can exclude undesirable components from entering the polymer and interfering with measurement of the analyte of interest. These sensors are suited for measuring an analyte, such as oxygen, present in volatile organic solvents from different sources.

The disclosure further provides methods for preparing the sensors. In some embodiments, the metal-ligand complex and the amorphous fluoropolymer are dissolved in a suitable solvent to form a homogenous mixture, which can be layered onto a substrate or poured into a mold. Removal of the solvent results in the formed sensor. An additional embodiment for preparing the sensors is to swell the polymer in presence of the solvent containing the metal-ligand complex and allowing the complex to penetrate into the polymer. Subsequent removal of the solvent results in entrapment of the metal-ligand complex in the polymer matrix. This swelling procedure is found to produce sensors of consistent thickness, sufficient sensitivity, and chemical resistance. As noted above, the formed polymers may be further processed to alter the average size of the polymer matrix to change the selectivity of the sensor to interfering components in the sample being analyzed.

The present disclosure further provides various sensor systems using the sensors described herein. Generally, the sensor system comprises (a) the sensor comprising the amorphous polymer containing the metal-ligand complex, (b) an excitation light source, and (c) a detector. The excitation light source may be a laser, a flashlamp, or a light emitting diode (LED). Some embodiments of this system use a plurality of light emitting diodes to generate an excitation light of sufficient intensity. In this system, each LED of a plurality of LEDs is mounted on a fiber optic line and the light from each LED combined to excite the luminescent molecule in the sensor. The detection of the emitted light is carried out using a photodetector, which can be used to measure the luminescence intensity or luminescence lifetime of the luminescent metal-ligand complex.

The sensor and the sensor system are applicable for measuring analytes in samples or environments not suitable for other types of sensors. For instance, the sensors of the present disclosure can be used to detect oxygen in environments containing volatile organic solvents, such as in aircraft fuel tanks. The sensor systems for such purposes may use a single sensor, or in some embodiments, a plurality of sensors where at least a first sensor is in contact with the organic solvent and at least a second sensor is positioned above the fuel to detect the oxygen in the gaseous phase. In another application, the sensors of the present invention may be used to detect air in environments containing hydraulic fluid, and air in hydraulic fluid itself. By measuring oxygen in hydraulic fluid, the amount of air in the hydraulic fluid may be determined. If the amount of air in hydraulic fluid can be detected, the fluid may be treated to remove excessive air, in order to reach acceptable air levels, e.g., for many applications 8-10 percent, or to reach air levels in which air can be absorbed by the hydraulic fluid, e.g., for many fluids 5-6 percent.

In other applications, the sensor in the form of film may be incorporated into vacuum packages, such as in containers for food and pharmaceuticals, to measure oxygen in the packages for purposes of quality control or to detect tampering. The sensor in the package is excited and the emitted light detected using an external unit containing the light source and the photodetector. The low cost of the sensor films described herein, their sensitivity, and durability are well suited for such large-scale commercial applications. The sensors may also be used in wastewater treatment plants, fermentation processes (e.g., wine and drug manufacture), and reactors used in polymer synthesis.

### BRIEF DESCRIPTION OF THE DRAWINGS

FIG. 1 is an illustration of the structure of platinum (II) meso-tetra (pentafluorophenylphorphine) (Pt(TFPP)).

FIG. 2 is a graph of luminescence decay curves of a Pt(TFPP)/Teflon AF film before (solid line) and after (dotted line) overnight exposure to JP 8 jet fuel.

FIGS. 3A, 3B and 3C depict schematic representations of three oxygen sensor systems according to embodiments of the present invention.

FIG. 4 depicts a schematic of a sensor system deployed to measure oxygen in jet aircraft fuel tanks, according to an embodiment of the present invention.

FIG. 5 illustrates the performance of the sensor system in measuring varying oxygen levels at constant temperature and pressure.

FIG. 6 depicts the relationship between temperature and the fluorophore's luminescence lifetime for 8% oxygen as measured by the sensor system.

FIG. 7 is an illustration of the relationship of the decay moment for 20% oxygen at various pressures and at constant temperature.

FIG. 8 is an illustration of the weighted average lifetime of a bi-exponential fit as oxygen concentration is varied.

### DETAILED DESCRIPTION

The present disclosure provides sensors for detecting analytes in a sample by use of luminescent molecules, also referred to herein as a luminescent dye or dye molecule, that change properties upon interaction with the analyte of interest. Generally, the luminescent molecule is incorporated into polymer matrixes that control access to the dye molecule. In the sensors described herein, the polymeric material provides a structural host for the luminescent dye, has a high degree of optical transparency, is mechanically and chemically durable, and provides selectivity for the analyte of interest.

According to embodiments of the present invention, sensors are suitable for detecting a variety of analytes that are capable of diffusing through the polymer matrix and altering the properties of the luminescent molecule. Exemplary analytes include, by way of example and not limitation, oxygen, chlorine, nitric oxide, ammonia, carbon monoxide, or hydrogen sulfide. Measurable properties of the luminescent molecule include, among others, excitation wavelength, emission wavelength, intensity, and/or luminescence lifetime.

In some embodiments, measurement of the analyte concentration, for example oxygen, may be based on the physical effect of the luminescence quenching of a dye. Luminescence is observed when a molecular or atomic system (luminophore) in an excited state relaxes in the ground state by the emission of light. A variety of processes may give rise to non-radiative relaxations of the luminophore, thus changing of the luminescence intensity and lifetime. This phenomenon is known as luminescence quenching. For instance, oxygen behaves as a collisional (i.e., dynamic) quencher for a large family of indicators, such as polycyclic hydrocarbons, metal-organic complexes, and heterocyclic compounds. When molecular oxygen interacts by means of collisions with any of these indicators, a change correlated to the oxygen content of either luminescence intensity and lifetime is observed. The relation between intensity and lifetime towards quencher concentration may be described by the following Stern-Volmer equation:

$$\frac{{τ}_{0}}{τ} ≡ \frac{{I}_{0}}{I} = 1 + {K}_{SV} \cdot c \qquad ( 1 )$$

where τ, I, τ₀, I₀ are the luminescence lifetimes and intensities with and without the quencher, respectively, c is the quencher concentration, and Kₛᵥ is the Stern-Volmer constant. From the equation, it can be seen that an increase of oxygen concentration causes a decrease of the luminescence intensity and a shortening of the luminescence lifetime. The concentration of oxygen may be determined from this equation once the luminescence intensity ratio and the Stern-Volmer constant are obtained.

In order to accurately detect the presence of analytes in a sample, a polymer matrix that contains the luminescent sensor may include the following characteristics: (1) high degree of transparency for the light used to excite the luminescent molecule, as well as for radiation emitted by the dye molecule, (2) sufficient permeability but selectivity for the analyte, and (3) mechanical and chemical durability.

To provide such characteristics, according to one embodiment which is described herein, the sensor employs an amorphous fluorinated polymer. In some embodiments, the amorphous fluorinated polymer is Teflon AF, a polymer characterized by outstanding optical clarity, superior light transmission, high permeability to gaseous analytes, and chemical resistance to all but a few select solvents. Teflon AF is a derivative of poly-tetrafluoro-ethylene (a copolymer formed of tetrafluoroethylene (TFE) and 2,2-bistrifluoromethyl-4,5- difluoro-1,3-dixol). There are several commercially available versions of Teflon AF. For example, Teflon AF 2400 (Random Technologies, San Francisco, Calif., Teflon AF 2400 Film, 2 mil.) and Teflon AF 1600 are both copolymers of perfluoro(2,2-dimethyl-1,3-dioxole) and tetrafluoroethylene with different concentrations of the constituents. Teflon AF 1600 has a dioxol content of 65 mole percent and Teflon AF 2400 has a dioxol content of 85 mole percent. The polymers are soluble in selected fluorinated or perfluorinated solvents, making it possible to easily cast films and to incorporate luminescent molecules. Teflon AF films can be processed (e.g., heat, compression, stretching) to alter the average size of matrix pores, thus improving its ability to exclude from the sensor matrix components that can change the luminescent molecule's environment.

In the sensors described herein, the analyte sensitive luminescent molecule comprises a luminescent molecule whose luminescence properties are dependent on the concentration of analyte present. Generally, the luminescent molecule is a luminescent metal-ligand complex. Typically, the metal in the metal-ligand complex is a transition metal. Suitable transition metals include, by way of example and not limitation, cadmium (Cd), copper (Cu), cobalt (Co), palladium (Pd), zinc (Zn), iron (Fe), ruthenium (Ru), rhodium (Rh), osmium (Os), rhenium (Re), platinum (Pt), scandium (Sc), titanium (Ti), Vanadium (V), chromium (Cr), manganese (Mn), nickel (Ni), molybdenum (Mo), technetium (Tc), tungsten (W), and iridium (Ir). In some embodiments, the transition metal is the first series of transition metals, including Fe, Re, W. Mo and Tc, along with the platinum metals, such as Ru, Rh, Pd, Os, Ir and Pt.

The ligand in the metal-ligand complex is a molecule or ion bonded to a metal atom. In some embodiments, the ligand bonded to the metal ion may be a mono or polydendate ligand. For purposes of illustration, a monodentate ligand is a ligand that forms one ligand-metal bond while a bidentate ligand is a ligand that forms two ligand-metal bonds. When multiple ligands are bonded to the metal atom, such as in metal-ligand complexes formed with bidentate or tridentate ligands, the ligands may be the same (i.e., homometallic) or different (i.e., heterometallic). As further described below, the ligands may be fluorinated to enhance their solubility in the solvents used to swell or solubilize the fluoropolymer.

In some embodiments, the polydentate ligand comprises a bidentate ligand, including, by way of example and not limitation, bipyridine and phenanthroline, and derivatives thereof. Exemplary fluorinated bidentate ligands include, 5-pentafluorobenzamide-1,10-phenanthrolin, 5-pentafluorobenzamide-1,10-phenanthrolin, and 4,4′-di-(3,3,4,4,5,5,5-heptafluoropentyl)-2,2′-bipyridine, as described in U.S. Pat. No. 6,653,148, incorporated herein by reference.

In other embodiments, the polydendate ligand comprises tridentate or terdentate ligands. An exemplary class of tridentate ligands with luminescent properties is terpyridines and its derivatives, which are described in Hofmeier, H. et al., Chem. Soc. Rev., 33 (6):373-399 (2004). Other tridentate ligands are described in, among others, Willison, S. A. et al., Inorg Chem. 43(8):2548-55 (2004), and Hu, Y. Z. et al., Dalton Trans. 2:354-8 (2005). All references are incorporated herein by reference.

In some embodiments, the ligand is a macrocycle, which refers to a macrocyclic compounds where the macrocycle forms a cage structure that binds and encapsulates (i.e., chelates) the metal. In some embodiments the macrocycle is based on porphine, and its derivatives, such as porphyrins. Porphines are macrocyclic tetrapyrroles with conjugated double bonds, where the center of the porphine ring is suited for accommodating metals of the first transition series. Porphine, including porphyrin and porphyrin derivatives, are described in Comprehensive Coordination Chemistry, (Wilkinson et al. eds), Chapters 13 and 21, Pergammon Press (1987), and U.S. Pat. No. 4,810,655, all of which are hereby expressly incorporated by reference. Exemplary porphyrins include, by way of example and not limitation, tetramethoxyphenyl porphyrin and azatetrabenzoporphyrins (U.S. Pat. No. 5,318,912) and oxoporphyrins (U.S. Pat. No. 5,718,842). Porphyrin-like aromatic macrocycles, including the sapphyrins, oxosapphyrins, platyrins, texaphyrins, and pentaphyrin are described in U.S. Pat. Nos. 5,252,720 and 5,512,675.

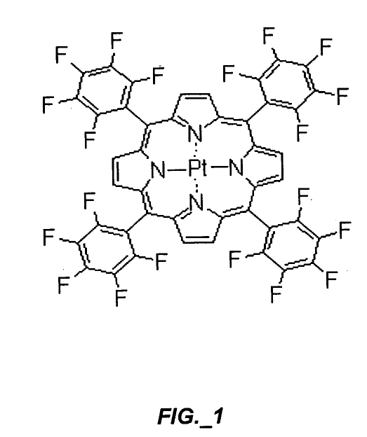

An exemplary luminescent molecule utilizing a fluorinated macrocyclic porphyrin is a platinum chelate (platinum (II) meso-tetra (pentafluorophenylphorphine) Pt(TFPP). The chemical structure of Pt(TFPP) is depicted in FIG. 1. Pt (TFPP) is highly fluorinated, making it chemically compatible with Teflon AF and has strong luminescence characteristics. Due to its large aromatic structure, the metal-ligand complex has a significant Stokes shift, where the dye can be excited in the near-UV and detected in the visible spectrum. This large Stokes shift makes optical filtering a relatively simple process.

General procedures for synthesis of porphyrins are described in The Porphyrins, Vol. 6, Chap 3-10, pp. 290-339, (Dolphin, D. ed), Academic Press, New York, N.Y. (1979); Smith, K. M. et al., Heterocycles, 26(7):1947-63 (1987); Lindsey, et al., J. Org. Chem. 52:827-836 (1987); Momenteau, M. et al., J. Chem. Soc., Perkin Trans. I:283 (1988); Morgan, B. et al., J. Org. Chem. 52:5364-5 (1987); Smith, K. M. et al., J. Org. Chem. 51:666-671 (1986); and Smith, K. M. et al., J. Chem. Soc., Perkin Trans. I:277-280 (1986).

Another type of macrocyclic ligand is phtalocyanines, which are generally used as dyes and pigments, but which also display luminescent properties. Phtalocyanines are porphyrin-like synthetic compounds that are structurally and functionally related to porphyrins. The phtalocyanine ring system is similar to that of the porphyrin ring system with the addition of an aromatic ring on each pyrrole ring and the replacement of the meso position carbon atoms by nitrogen atoms. Organometallic derivatives of phtalocyanine are described in J. Chem. Soc, Faraday Trans. 1, 80(4):851-863 (1984); J. Phys. Chem. Solids, 49(9):1003-1008 (1988); Sensors and Actuators 15(4):359-370 (1988); and U.S. Pat. No. 5,346,670.

In other embodiments, the macrocycles comprise cyclen, which is 1,4,7,10-tetraazacyclododecane, or cyclam, which is 1,4,8,11-tetraazacyclotetradecane. Derivatives include 1,8-bis(pyridylmethyl)cyclam and 1,11-bis(pyridylmethyl)cyclam. For cyclen macrocycles, the unsubstituted secondary tetraamine does not completely encircle the metal ion such that the metal ion lies out of the plane of the four nitrogen donor atoms of the macrocycle. Cyclen derivatives with pendant arms, however, can coordinate a large variety of metal ions in an axial fashion, so that the central metal ion is positioned between the planes of the four nitrogens and the planes of the donor atoms (usually oxygen) of the pendant arms. Cyclam is sufficiently large and flexible enough to coordinate to metals of different sizes. Other macrocyclic ligands that coordinate to metals and form luminescent complexes will be apparent to the skilled artisan.

Generally, the ligands are sufficiently fluorinated to enhance solubility of the metal-ligand complex in the fluorinated solvents or perfluorinated solvents used for swelling or dissolving the fluoropolymer, as further described below. Thus, the ligands when fluorinated have at least one fluorine molecule. Typically, the ligands are “substantially fluorinated,” which refers to about 40% or more of the hydrogen atoms of the ligand having been replaced by fluorine atoms. In some embodiments, the ligands are “highly fluorinated”, which refers to about 70% or more of the hydrogen atoms having been replaced by fluorine atoms. However, it is to be understood that in some embodiments, fluorination or the degree of fluorination is not critical as long as the ligand is soluble in the solvent used to swell or dissolve the amorphous fluoropolymer.

Fluorination of ligands, including macrocyclic ligands such as porphyrins, are described in, among others, Ornote, M. et al., Tetrahedron 74:1868 (1994); Onda, H. et al., Tetrahedron Lett. 26:4221-4224 (1985); Kaesler, R. W. et al, Org. Chem. 47:5243-5246 (1982); Chambers, R. D. et al., J. Chem. Soc. Perkin Trans. 1:803-810 (1999); Grimmett, M. R., Adv. Heterocycl. Chem. 59:246 (1994); Silvester, M. J., Adv. Heterocycl. Chem., 59:1 (1994); and Nguyen, F. et al., J. Fluorine Chem. 94:15-26 (1999). All references are incorporated herein by reference.

It is to be understood that while the sensor may have a single type of luminescent metal-ligand complex, the sensor may also contain combinations of luminescent molecules to provide additional responsiveness to different environmental and sampling conditions. The combinations may include a single type of ligand but with different types of metals, or different types of ligands with the same or different type of metal. For instance, a combination of metal-ligand complexes may be a first metal-ligand based on bidentate ligands and a second metal-ligand complex based on macrocyclic ligands. Other variations will be apparent to the skilled artisan.

The sensors described herein may be made in various ways. In some embodiments, the sensor is made by swelling a thermo-processed fluoropolymer with a suitable solvent containing the metal-ligand complex. The “swelling”, as used herein, refers to exposing the polymer to the solvent without completely dissolving the polymer in the solvent. The polymer, typically in the form of a film, remains in contact with the solvent-dye mixture until a sufficient quantity of metal-ligand complex has entered the polymer matrix. Subsequent removal of the solvent leaves the metal-ligand complex trapped within the polymer. In some embodiments, all surfaces of the polymer are exposed to the solvent, thereby providing a sensor with metal-ligand complex embedded in all surfaces of the polymer. In other embodiments, only selected surfaces of the polymer are exposed to the solvent, thereby providing a sensor with metal-ligand complex embedded in only the selected polymer surface. This may be achieved by creating a seal that forms a reservoir over the selected surface where the solvent is applied. Thus, in some embodiments, a sensor with a luminescent metal-ligand complex on a first surface, or a first and second surface, may be formed. The amount of trapped metal-ligand complex in the polymer network is readily measured by spectroscopic techniques.

In other embodiments, the sensor is made by dissolving the metal-ligand complex in the solvent and adding a fluoropolymer to the solution to form a homogeneous solution of luminescent metal-ligand complex and fluoropolymer. The sensor is formed into a desired shape by pouring or spreading the solution on a surface or a shaped mold or by pressure rolling. The solvent is subsequently removed either by evaporation or by other means, such as in a controlled vacuum or by heating.

Suitable solvents of fluoropolymers are generally polyfluorinated and perfluorinated solvents. These include, by way of example and not limitation, perfluoroaliphatic (e.g., perfluoro(butyl THF)), polyfluoroaliphatic (e.g., C₃F₇ OCHFCF₃) and perfluoroaromatic (e.g., hexafluorobenzene) solvent systems. Exemplary solvents comprise perfluoro(butyl THF); a mixture of perfluorotrialkylamines containing perfluoro(di(n-butyl)methylamine; perfluorophenanthrene; hexafluorobenzene; octafluorotoluene; perfluoromethylcyclohexane; and perfluoro(n-ethylmorpholine). Compatible mixtures of solvents may also be used to form the sensor. Others solvents will be apparent to the skilled artisan.

The concentration of metal-ligand complex used in the solvent will depend on the solubility properties of the complex, the type of solvent, and the amorphous fluoropolymer used to form the sensor. For purposes of illustration and not limitation, the concentration of the metal-ligand complex in the solvent will range from about 10⁻⁷ to about 10⁻¹ M, and preferably from about 10⁻⁴ to about 10⁻² M. The concentration of metal-ligand complex in the polymer matrix will be proportional to the sensor concentration in the solvent used to form the sensor.

The thickness of the sensor is such that a sufficient response to the analyte being measured is obtained and at the response time desired. The skilled artisan can readily determine these aspects of the sensor. Thicker sensors may have slower response times, because a longer time is required for the analyte to diffuse into the polymer matrix as compared to a thinner sensor. However, the thicker sensors may provide a stronger detectable signal due to the higher amount of metal-ligand complexes in the polymer, and may have a longer useful life in harsh monitoring environments. Thus, for the amorphous fluoropolymer, the thickness of the polymer material will range from about 1 μm to about 250 μm, and in some embodiments from about 25 μm to about 75 μm.

The formed sensor may be used directly without further processing, or processed to alter the polymer characteristics. In some embodiments, the sensor polymer matrix is designed to exclude components other than the analyte of interest. It can also be designed to concentrate selected components of interest, thus enhancing the sensor dye's response. This will allow for the design of highly selective sensors, which are sensitive to components of interest and insensitive to other components in the sample being monitored. Thus, in some embodiments, processing may be used to reduce the average pore size of the polymer matrix, resulting in a polymer that selectively excludes components of a sample that could interfere with properties of the luminescent molecule. Processing fluoropolymers to alter pore size is described in Liu, et al., “Free Volume and Oxygen Transport of Cold Drawn Polyesters,” Journal of Applied Polymer Science, 92:749-756 (2004); Yu J. et.al., “Free Volume of Oxygen Transport of Cold-Drawn Polyesters,” Journal of Applied Polymer Science, Part B-Polymer Physics, 42:493-504 (2004); and Baer, E. et. al., “Barrier Properties of Polyesters-Relationship Between Diffusion and Solid State Structure”, Polymer Materials: Science and Engineering, 89:19-20 (2003); all publications incorporated herein by reference. The useful average pore size will depend on the analyte being measured and the components to be excluded from the sensor matrix. Thus in some embodiments for measuring oxygen, the average pore size is equal to or less than about 0.0024 μm, or in some embodiments, less than about 0.00086 μm (see, e.g., Wang, X. Y. et al., Polymer 45(11):3907-3912 (2004)).

A variety of systems may be devised to measure an analyte of interest, such as oxygen. Generally, the basic opto-electronic system used to measure the luminescence changes includes an excitation light source, a photo-detector, a medium for delivery of the excitation light, and a means of collecting and delivery the dye's emission light to the photodetector. The combination of the sensor and opto-electronic system yields a sensor instrument or a sensor system.

The sensor in such systems may be on a transparent substrate through which the excitation and emission light passes. The transparent substrate will have the characteristics of optical clarity and, where needed for positioning the sensor or to support the sensor, sufficient rigidity. Various substrates may include, by way of example and not limitation, glass, quartz, mylar, fused silica, and fiber optic material. The sensor may be mounted on the substrate directly, or on an intervening layer of another substrate. In some instances, the sensor is on an opaque substrate. This arrangement is used when one face of the sensor, opposite to that of the face bound to the opaque substrate, is being used to measure the analyte. Opaque substrates, include, by way of example and not limitation, metal, circuit board material, non-transparent plastics, and ceramics.

Generally, the light source used to excite the analyte-sensing molecule in the polymer will be a pulsed or modulated light source. In some embodiments, the excitation light source is light emitting diodes (LEDs) (Nichia Corp., Japan, NSPE500S-FT, blue-green LED 505 nm) or flashlamps. LEDs are cost effective. A single LED source may be used, or where higher intensity of excitation light is desired, a plurality of LEDs is used, where light from each LED is combined together to excite the sensor, typically via a fiber optic material. To increase the coupling efficiency of the LED to the fiber optic, the protective window of the LED may be removed, and the fiber optic material mounted directly to the diode element. The plurality of LEDs operating in parallel is pulsed or modulated simultaneously and in unison by a single electronic signal (e.g., from a digital signal processor). When such a plurality of LEDs are used, the number of LEDs may be from about 2 to about 20, from about 4 to about 12, from about 8 to about 10 LEDs, or a number sufficient to generate the intensity of excitation light required for the intended use. Generally, the excitation light from the LEDs is passed through an appropriate filter to generate the proper wavelength of light needed to excite the luminescent molecule.

In other embodiments, the excitation light source is a laser source. Various laser sources are available, for instance, microchip lasers and chopped continuous wave lasers. Lasers produce high intensity light and offer the possibility of monitoring several sensors through use of fiber optic lines that direct the excitation light from a single laser source to multiple sensors. This may be useful in a system configured to monitor the analyte in multiple sampling locations or environments, such as in an aircraft where there are multiple fuel tanks. Microchip lasers are commercially available through JDS Uniphase and Northrop Grumman, such as a passively Q-switched Nd:YAG laser, which outputs 500 ps pulses at a frequency of 2-8 KHz. This laser is commercially available in a frequency-doubled output (532 nm; green) of several μJ/pulse; the shot-to-shot stability is <1%.

The detector may be those commonly known and used in the art. These may include, by way of example and not limitation, a photomultiplier tube (PMT), a photodiode (PD), or an avalanche photodiode (APD). The advantage of the PMT is its very high gain (>10⁶), which allows the easy detection of low light levels. The PD is smaller in size, making it adaptable to confined environments, and is lower in cost than a PMT, but has a lower gain. APD is slightly larger than the PD (including power supplies) and has gain that is higher than the PD.

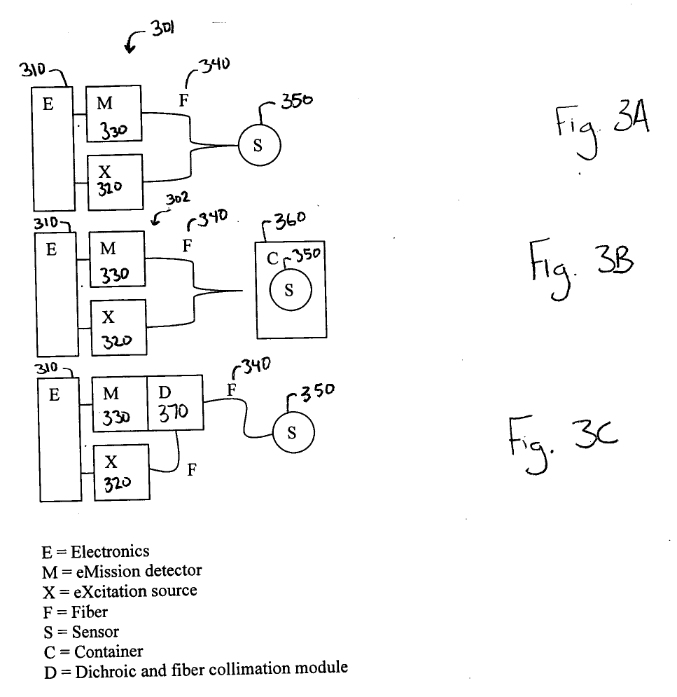

For purposes of illustrating the principles of the system in accordance with embodiments of the present invention, three embodiments are described in FIGS. 3A, 3B, and 3C. In FIG. 3A, the sensor is affixed mechanically to a fiber optic probe consisting of an excitation light delivery fiber and an emission light collection fiber. According to FIG. 3A, the system 301 includes electronics (E 310), excitation source (X 320), emission detector with the appropriate filter (M 330), a bifurcated fiber optic probe (F 340), and sensor (S 350). In this embodiment, two small-diameter fibers are coupled to one large-diameter fiber. The distal end of the bifurcated bundle will be butt-coupled to the large-diameter fiber. For example, a short fiber (˜1 cm) having a large-diameter may be coupled to a distal end the oxygen-sensing film. This fiber may be mounted in a plug making it possible to easily replace or interchange the sensors. Alternatively, as depicted in FIG. 3B, the sensor may be placed inside a sealed environment with a clear window, where the luminescent measurement may be made remotely. The embodiment 302 of FIG. 3B includes the items of FIG. 3A along with a container (C 360) that is separate from the instrument.

According to the embodiment 303 of FIG. 3C, the system may include the components of FIG. 3A, along with a dichroic and fiber collimation module (D 370), and an additional fiber optic probe (F 340). Using the a dichroic and fiber collimation module (D 370), the system is capable of both delivering the excitation light and returning the emission light using a single fiber. The additional fiber optic probe (F 340) couples module (D 370) to excitation source (X 320). The embodiments described in FIGS. 3A-3C are by way of example, and not limitation.

According to embodiments of the present invention, a fiber-optic probe enables the sensor to be placed some distance from the electronic components because the fibers are flexible and can be easily routed around existing components, thereby making it easy to retrofit the sensors into the environment being measured. In addition, the probe itself may be made a few millimeters in diameter, which may facilitate easy placement in the sampling environment.

In some embodiments, the system may further comprise pressure and temperature sensors. These sensors will provide a basis for compensating for variations in properties of the luminescent molecule as a function of temperature and pressure. Although the measurement of analyte concentrations based on luminescence lifetime may minimize the effects of these two physical factors, compensating for such variations may provide more accurate measurements.

For measuring the concentration of an analyte such as oxygen, two approaches may be used for sensors based on a luminescent dye. The first, and that which is used in commercial instruments, relies on measuring the luminescence intensity. Although applicable in some situations, this straightforward approach is hampered by the need to frequently calibrate the instrument to compensate for excitation source variation and other factors. The need arises from the fact that luminescence intensity is based on several factors that include, among others, quantum yield (a molecular parameter) and instrumental variables, such as changes in excitation source intensitypossible probe wetting, and changes in collection efficiency, dimolecule degredation or leeching.

A second approach to measuring the concentration of an analyte is to measure the luminescence lifetime. The luminescence lifetime is an innate molecular property and is not impacted by instrumental variables. Therefore, once Kₛᵥ has been determined in the laboratory, it is not necessary to recalibrate the instrument, because the measured lifetime can be directly related to the oxygen concentration. Methods for measuring the luminescence lifetime is described in U.S. published patent application No. 2002/0158211, incorporated herein by reference in its entirety. In some embodiments, the sensor is excited with a light pulse of short duration followed by measurement of the temporal pattern of the subsequent luminescence. The luminescence intensity vs. time interval expressed relative to the time at which the excited state population generates a luminescence decay curve. This decay profile may be obtained by direct recording with a transient digitizer or digital oscilloscope. Alternatively, a histogram of the decay curve can be constructed by photon counting. Direct recording and photon counting are examples of time-domain methods. Substantially equivalent information on the dye decay properties can be generated by frequency domain (FD) methods. TF and FD methods, as well as other techniques for measuring properties of luminescent molecules, are described in Principles of Fluorescent Spectroscopy, 2^{nd} Ed. (Lakowicz, J. ed.) Plenum Press (1999), incorporated herein by reference in its entirety.

The sensor device and systems may be used in a number of different applications. In some embodiments, the sensor is used to measure oxygen levels in environments where interfering components are present. One such application is in fuel tanks where ascertaining the oxygen level is important for preventing combustion of the fuel. Thus, the system may comprise a sensor positioned in the environment containing the volatile organic solvent, where the sensor comprises an amorphous fluoropolymer with the luminescent metal-ligand complex.

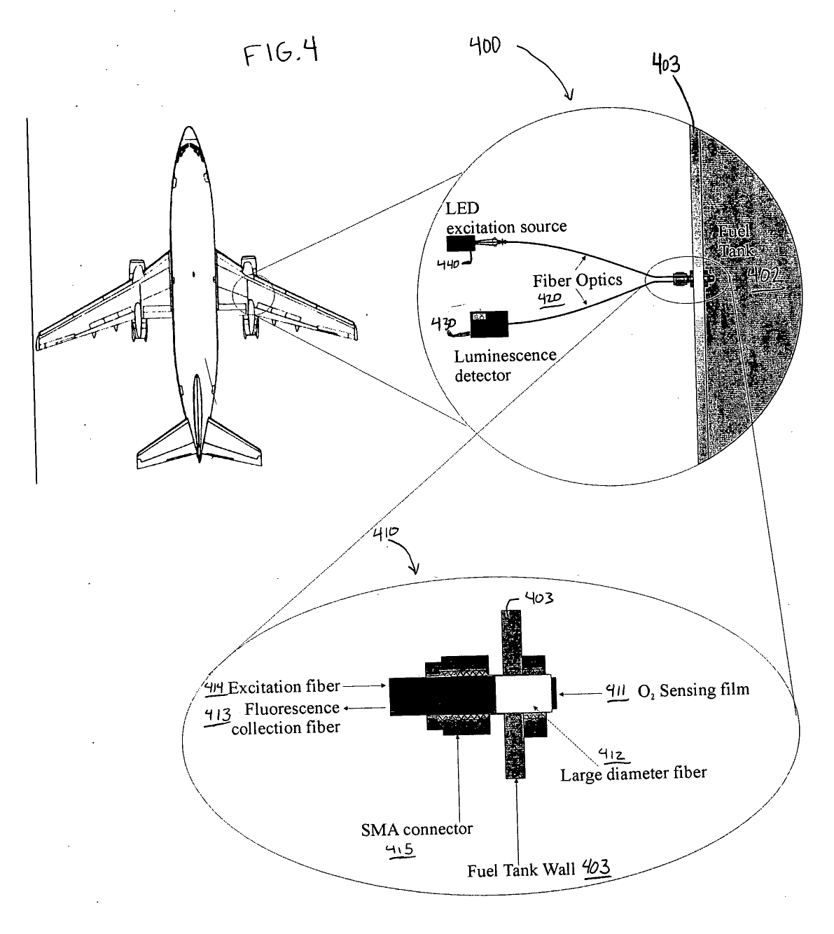

For purposes of illustration, a system 400 for measuring oxygen levels in an aircraft fuel tank will have the arrangement shown on FIG. 4. According to this illustration, a sensor 410 is placed in a fuel tank 402 and a fiber optical bundle 420 optically connects the sensor to the rest of the instrument 430, 440 that is safely exterior of the walls 403 of the ignitable fuel tank. Sensor 410 includes O₂ sensing film 411 coupled to a large diameter fiber 412. The O₂ sensing film 411 is disposed in an area where air or fuel in fuel tank 402 can be analyzed. The large diameter fiber 412 couples the O₂ sensing film 411 to an excitation fiber 414 and a luminescence collection fiber 413 via a SMA connector 415. According to the embodiment of FIG. 4, the excitation fiber 414 is coupled to LED excitation source 440, and luminescence collection fiber 413 is coupled to luminescence detector 430. Real-time monitoring of the oxygen levels based on the measured luminescence of the sensor 410 in the fuel tank 402 may be provided to the flight deck by the instrument. This information may be used to trigger, or alert the need for in-flight or ground-based inerting, which involves displacing most of the oxygen dissolved in the fuel with nitrogen by a fuel scrubbing process, and displacing the air in the fuel tank empty space with nitrogen-enriched air by an ullage washing process.

In the system 400 of FIG. 4, a single sensor may be used to measure the concentration of oxygen dissolved in the fuel and relate the oxygen concentration in the headspace above the fuel through Henry's law, which states that in a dilute solution, the equilibrium concentration (i.e., the solubility) of a dissolved gas is proportional to its partial pressure. Alternatively, a single sensor may be used to measure the concentration of oxygen in the headspace using sensors located in the headspace. However, the reaction time of the sensor depends on the placement of the sensor, and the sensors may sense oxygen content faster when immersed in fuel. In other embodiments, a plurality of sensors may be positioned throughout the fuel tank. In this embodiment, the plurality of sensors comprises at least a first sensor in contact with the fuel and at least a second sensor in the ullage space. With this approach, at least some subset of sensors will not be immersed and will be relied upon to make the headspace measurement. By knowing the volume of fuel remaining in the tank and the altitude of the aircraft, the sensing system should be able to calculate which sensors are immersed and which are not and make measurements accordingly.

Several other fields will benefit from this sensor technology as well. In environmental monitoring applications, it is oftentimes necessary to measure the oxygen concentration in environments with substantial volatile organic chemical content, such as in petroleum manufacturing and transport industries. Additionally, in the wastewater treatment industry there is a need to measure oxygen concentration. In this application, the presence of bacteria can substantially degrade sensor performance. Since Teflon AF is relatively resistant to bacterial growth, the sensors of the present disclosure may be positioned in contaminated waste water systems to measure oxygen content.

Another application of the sensor is trace oxygen analysis in vacuum chamber process monitoring, such as in plasma deposition and other vacuum related materials processing. The sensor system may be used to check the integrity of vacuum packed packages, such as pharmaceutical products, blood products (e.g., whole blood, plasma, and platelets), and vacuum food packaging. The sensor film may be included in the packages and checked on line or at the point of sale by use of an external, integrated point and detect measurement device. Furthermore, the oxygen sensors placed in packages could also serve as tamper monitors and as security procedures for certain types of shipping containers.

In yet a further application, the sensor system is used to monitor oxygen in samples containing volatile hydrocarbons. These include monitoring oxygen in fermentation processes (used for wine and drug manufacture) and reactors used in polymer synthesis. The sensors described herein could be placed on a probe without the need to recalibrate the sensor for substantial periods of time (e.g., weeks to months). Other similar types of applications will be apparent to the skilled artisan.

In another implementation, one or more sensors of the present invention may be used to detect air in environments containing hydraulic fluid and in hydraulic fluid itself, which can be composed of up to about 18 percent air at normal temperature and pressure. By measuring oxygen in hydraulic fluid and in the open spaces in hydraulic equipment, the amount of air in the hydraulic fluid and the surrounding area may be calculated. This may be useful for hydraulic equipment because excessive air in hydraulic systems can cause cavitation, in which air comes out of fluid, resulting in damage to hydraulic components and degradation of the hydraulic fluid. If the amount of air in hydraulic fluid can be detected, the fluid may be treated to remove excessive air, in order to reach acceptable levels.

### EXAMPLES

### Example 1

Preparation of Oxygen Sensor

Swelling method. In one embodiment, the sensor construction procedure is as follows. A circular coupon with roughly ¼ inch diameter and 50 μm thickness is cut from a sheet of the amorphous fluorinated polymer. The dye is dissolved in octafluorotoluene. The amorphous fluorinated polymer coupon is then placed in contact with this dye-octafluorotoluene solution until the octafluorotoluene evaporates, or a sufficient amount of dye has been absorbed into the amorphous fluorinated polymer. Following drying, the sensor coupon is washed with acetone to remove residual dye from the surface. In another embodiment, the sensor construction includes treating a sheet of amorphous fluorinated polymer with the dye-octafluorotoluene solution, followed by cutting coupons out of the sheet.

Homogeneous solution method. In this method, the sensor is prepared from Pt(TFPP) dissolved in a suitable solvent together with Teflon AF 2400. Dissolving a small amount of Teflon AF 2400 in perfluorohexanes produces a film solution. Then, a few milligrams of Pt(TFPP) are dissolved in perfluorotoluene. Next, the two solutions are mixed together to make a viscous orange solution. The tip of the fiber-optic probe is dipped into the mixture and removed. Heating the probe to approximately 100° C. evaporates the solvent, leaving a sensor film deposited on the fiber optic surface. The probe is rinsed with toluene to remove any loosely bound Pt(TFPP).

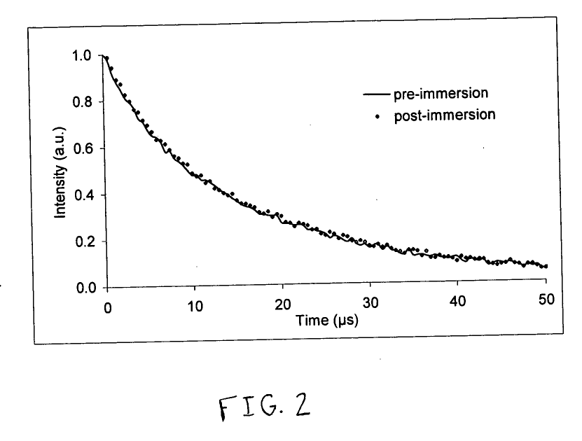

Performance of sensors. To determine sensor performance, green light (532 nm) from a microchip laser was launched into the excitation fiber. The detection fiber was mounted on a photomultiplier tube that had a 600 nm optical cut-on filter. The PMT was terminated into 10 kW load and connected to a digital storage oscilloscope where the waveform was recorded. One waveform was collected (solid line in FIG. 2) and then the probe was immersed in JP 8 jet fuel overnight and a second waveform (dotted line in FIG. 2) was collected the following day. As seen in FIG. 2, the two waveforms are practically indistinguishable, indicating that there is no degradation of the sensor even after exposure to jet fuel. When the probe is immersed in JP 8 jet fuel for longer periods, such as one week, the same waveform curve as the overnight immersion waveform results.

For a 1-to-1 mixture of air and nitrogen (˜10% oxygen) the observed decay was fit to a biexponential model with luminescence lifetimes of 2.79 microseconds and 0.49 microseconds. For luminescent probes in polymer matrices biexponential models are typically needed to fit the data to account for the distribution of luminescent probes within the matrix. For an air/nitrogen mixture corresponding to 8% oxygen the lifetimes obtained were 2.94 microseconds and 0.52 microseconds.

### Example 2

Probe Design

Generally, the sensor probe is designed to allow easy testing and interchangeability of sensor films. The probe may be a 2:1 design with two small-diameter fibers (one each for luminescence excitation and collection) coupled to a single large-diameter fiber. The ultimate diameters will be determined experimentally. This 2:1 design will serve two purposes. First, it will make it easy to swap out the large diameter fiber for testing and replacement and will ensure sufficient optical coupling of excitation light to the sensing film and emitted light back to the detector. In some embodiments, as further described below, the excitation light source is light from multiple LEDs in which a fiber optic line from each LED source is combined onto the larger diameter fiber.

The sensing film may be applied to the distal end of the large-diameter fiber. For probes that will not be exposed to liquid fuels or high concentration fuel vapors for prolonged periods, the sensing films may be cast onto a transparent Mylar support and glued onto the probe using a suitable adhesive (e.g., Norland Optical Adhesive). Neither Mylar nor the optical adhesive is degraded by fuel when exposure is limited. For probes that will be exposed to liquid fuels and high concentration vapors for extended periods of time, the sensing film will be applied directly to the probe tip. Manufacturers recommended procedures for obtaining optimal adhesion of Teflon AF to glass may be used. Generally, this procedure involves first pretreating the glass with a fluorosilane before coating with Teflon AF.

### Example 3

Sensor System and Testing

Instrumentation. For a system using the analyte sensor described herein, the system used to record the sensor element's luminescence response includes LED sources, fiber optics, a wavelength selective emission filter, a photodetector, and an electronics package. The electronics consist of a Digital Signal Processor (DSP) running at 40 MHz clock speed and interfaced to a Complex Programmable Logic Device (CPLD) over the DSP's 16-bit databus. The CPLD has two 16-bit counters connected to high-speed comparators. The comparators monitor the photodetector to detect single photon events.

The light source is an array of eight 370 nm LEDs, operating in parallel, as further described below. The LEDs are driven by CMOS transistor pairs wired in an inverting configuration, with the LED in parallel with the P transistor. This configuration sharpens the falling edge of the LED excitation. LED pulsing is controlled by the DSP.

Owing to the relative weak emission signals, a photon counting approach to recording the emission is advantageous. In this system, the DSP “gates” the counting bins in order to time-resolve the luminescence decay. After the LEDs are pulsed, the decaying luminescence is measured by summing up the time resolved photon data, since the luminescence signal is so small, typically <2 photons received per bin per LED pulse, 1000-10,000 waveforms are summed in each data set. With an LED cycle-time of roughly 100 μs (10 kHz repetition rate), ten thousand pulses take one second to acquire. The number of photons is dependent on O2 concentration. 10's of photons or more are often seen per pulse across all bins.

Since there is dead-time between counting bins—necessary in the system herein to accommodate transferring the count value to the DSP, storage of the value, and clearing of the counter—subsequent window trains are delayed. For every 100 ns bin, there are 500 ns of dead time; the result is that it takes six interleaved acquisitions in order to acquire a single 120-point waveform. In order to interleave the sample data, the DSP delays the counting windows by inserting fixed delays between shutting the LED off and the enabling the counting window train. Since bin size is under software control, the effective sampling rate is variable and bin widths of 100, 250 and 500 ns were tested. The interleaved sampling allowed for more data points to be generated along the decay curve, which significantly increased accuracy and precision.

For the photodetector, the system employed a Perkin Elmer channel photomultiplier (CPM), which offers extremely high gain (up to 10⁸) and very low dark counting rate. Like other end-on photomultiplier tubes (PMTs), the CPM has a semitransparent photocathode material deposited on the inner surface of the entrance window. This CPM is distinguished from other PMTs in that the gain (electron amplification) does not involve a discrete dynode chain structure. Somewhat reminiscent of a microchannel plate, the photoelectrons are drawn by a bias voltage into a narrow semiconductive channel. Multiple secondary electrons are created each time an electron strikes the inner surface of the curved channel. This effect occurs multiple times along the path, leading to an avalanche effect with a very high gain. The curved shape of the glass tube improves the multiplication effect.

Fiber optics are advantageous for the intended application because they allow an optical-only connection between the excitation and detection hardware and the fuel tank. Any oxygen sensor that places electronic equipment near volatile organic solvents, such as in a fuel tank, adds to the potential danger from explosion due to sparking. Using the fiber optics, the instrument can be placed in a safe area.

The various optics in the system either act to collimate the light coming from the fiber bundles, focus light onto fibers, or filter out unwanted light wavelengths.

Excitation source based on LEDs. The source of excitation light is an array of LEDs. For maximum flexibility during the testing, eight LEDs operating in parallel were designed into the test system. The eight fibers were bundled on the distal end where the light passed through a filter and was then launched into a macro-core fiber (larger diameter fiber) for delivery to the sensor. Use of multiple LEDs has the advantages of continued operation even when some of the LEDs cease to function. The LEDs are pulsed simultaneously and in unison by a single electronic signal.

Test system. For the sensor calibration studies, certified gas mixtures were obtained from Praxair with 0%, 2%, 4%, 8%, 20%, and 100% oxygen, the balance being nitrogen. Mixtures with oxygen percentages between these fixed values were prepared by controlled mixing of the standards.

When total pressure or the fraction of oxygen in the mixture was changed, the system was allowed to equilibrate for at least one minute. Longer equilibration times were required in the temperature dependence studies. The sensor response time is very fast compared to the chamber equilibration times. The sensor provided the ability to monitor oxygen concentration in real-time. No experiments were conducted to specifically determine the very fast diffusion rate of oxygen through the Teflon AF/dye complex, but equilibrium is reached in less than ten seconds.

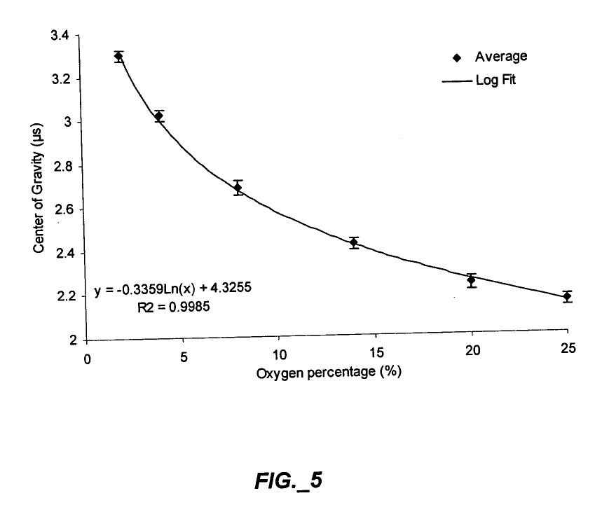

System performance in measuring varying oxygen concentration. The sensor system was examined for its ability to measure varying oxygen concentrations at constant temperature (25° C.) and total pressure. The test gas was slowly flowed through the sample chamber to prevent any entry of room air into the chamber. The measurements were performed in triplicate measurements at each oxygen concentration. The response of the oxygen sensor to the changes in oxygen concentration was faster than the time required to changeover the volume of gas in the hoses and the sample chamber. In FIG. 5, the mean standard deviation (shown as y-error bars in the figure) for the measurements was 0.03 μs. This equates to 0.5% between 10% and 15% where the transition from non-flammable to flammable mixture takes place. This value is well within acceptable performance.

System performance in measuring oxygen concentration at varying temperatures. Variation in the lifetime as a function of temperature can be expected even in the absence of oxygen quenching because radiationless processes such as internal conversion and intersystem crossing are generally temperature dependent. Sensor temperature also impacts the degree of oxygen quenching because the collisional rate constant depends on temperature.

A thermoelectric heat pump (Melcor, MPA250-12) was used to accurately control the temperature of the sample chamber between −10° C. and upwards of 40° C. A small and steady flow of known gas was continuously fed into the chamber to ensure no room air was present; the flow rate was kept constant for all experiments.

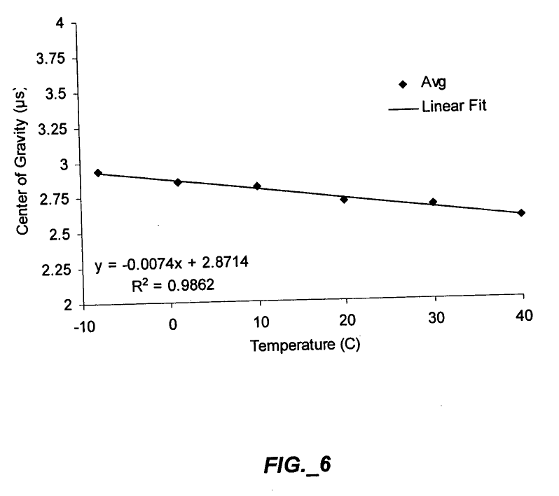

Failure to correct for the temperature variations commonly occurring in the fuel tank environment could lead to absolute errors in the amount of oxygen by as much as 5%. FIG. 6 shows the relatively linear relationship between temperature and the fluorophore's luminescence lifetime for 8% oxygen. By correcting for the temperature effects, the measurement error may be kept under 0.5%.

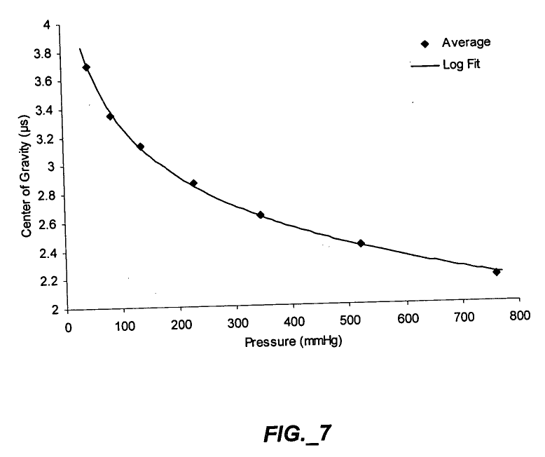

System performance in measuring oxygen concentration at varying pressures. The effect of pressure on oxygen measurement was investigated. A small positive flow of gas was fed into the system while it was being vacuum pumped to ensure the oxygen percentage did not change—most notably due to leaks in the system allowing room air to enter. FIG. 7 shows the relationship of the decay moment for 20% oxygen at various pressures and a constant temperature. All measurements were taken in triplicate and the relative standard deviation for any one point did not exceed 1%. This standard deviation is double that seen when pressure and temperature were both fixed. However, this increase in standard deviation can be attributed to small drifts and inconsistencies of the test platform rather than the oxygen sensor or photon counting system.

The x-axis in FIG. 7 can be altered to be the partial pressure, i.e., the total concentration, of oxygen present. In this manner, the pressure data at any one oxygen percentage can be correlated to an oxygen percentage at one atmosphere pressure. This shows that the sensor itself was not impacted by pressure variations. The impact of this relationship is that while pressure must be known, no correction factor need be applied other than the straightforward conversion to partial pressure of oxygen.

Stability of sensor performance. Sensor stability was tracked daily for a one-week period. Three measurements were made each day at 8% oxygen, 25° C., and 1 atmosphere. Table 1 shows the daily average as well as the week average and standard deviation. The overall standard deviation equates to a calculated oxygen percentage variation of 0.5%. The variation in the daily values from the one-week average appears to be randomly distributed.

TABLE 1
Daily repeat measurements (8% oxygen, 25° C., 1 atm)

| | Day | | | | | | | |
|---|---|---|---|---|---|---|---|---|
| | 1 | 2 | 3 | 4 | 5 | 6 | Avg | StDev |
| C (μs) | 2.699 | 2.657 | 2.712 | 2.683 | 2.676 | 2.706 | 2.689 | 0.021 |

Resistance of sensor to contaminating components and volatile organic solvents. The robustness of the sensor to fuel contamination was studied under two conditions. The first approach involved immersing the sensor in 50 mL kerosene for one month; repeat measurements of the sensor were taken at 0, 2, and 4 weeks. In approach two, the sensor was placed in 5 mL of hexane. Chosen for its much higher transparency compared to kerosene, hexane was checked via luminescence using a commercial fluorimeter for the presence of the dye molecule at 0, 1, 2, 3, 7, and 14 days.

Any leaching of dye from the sensor into the solvent was below the limit of detection. Once it was determined that the dye was held tenaciously within the Teflon AF, the question arose whether this was due to a much higher affinity of the dye for the Teflon AF environment rather than the fuel or if the dye becomes completely locked within the Teflon AF. In essence, the leakage process was tested in reverse. A volume of hexane was saturated with the dye and an untreated Teflon AF coupon was placed in the solution. After 72 hours, no transport of dye into the Teflon AF could be detected. This behavior is very different from experiments in which Teflon AF is placed in a swelling solvent along with the dye; in that case, substantial dye enters the Teflon AF matrix in less than a minute. Thus, the dye is strongly entrained by a physical mechanism within the Teflon AF, such that the dye neither ingresses or egresses in the absence of matrix swelling.

### Example 4

Sensor System Instrumentation Instrumentation for a system using the analyte sensor to record a sensor element's luminescence response described herein, may include a single LED source, fiber optics, a sample probe, a wavelength selective emission filter, a photodetector, and an electronics package. In addition, integrated pressure and temperature monitors may also be included in the system to allow for compensation of the measured oxygen levels based on environmental conditions.

According to one implementation, the light source may be a single LED with a nominal output of 505 nm and is butt-coupled to a 600 μm excitation fiber. The distal end of the excitation fiber may be coupled to a fiber collimator (Thorlabs, Inc., F220SMA-A). Coupled at a proximal end of the collimator may be a dichroic mirror (Semrock, FF555-Di02-25×36), which reflects the excitation light, and transmits the redder emission. According to the present implementation, the excitation light passes through a fiber collimator into a single fiber that both delivers the excitation light and returns the emission light.

The sample probe, according to certain implementations, consists of the single excitation/emission fiber mounted in a ¼ inch brass fixture with external threads on the terminated end. The fiber may be mounted flush with the end of the brass probe and polished to achieve maximum light efficiency. The sensor coupon may be held in contact with the fiber, for example, by means of a screw on cap that mechanically holds the sensor in place.

Collected emission light travels back through the fiber and is transmitted by the dichroic mirror. The light passes through a 650 nm filter with a 40 nm bandpass (Thorlabs, Inc., FB650-40) prior to striking the photodetector, which may be a red sensitive PMT module (Hamamatsu Photonics K.K., H6780-20).

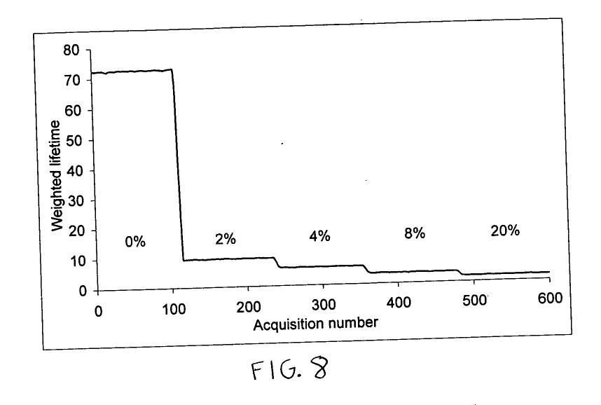

According to one implementation of the present example, the system's electronics may include a Digital Signal Processor (DSP) running at 150 MHz clock speed (Texas Instruments, TMS320F2812) and be interfaced to a Complex Programmable Logic Device (CPLD) over the DSP's 16-bit databus. The CPLD includes two 16-bit counters connected to high-speed comparators. The comparators monitor the photodetector to detect single photon events, and are synchronous to the DSP's clock cycle. Counting windows may be adjustable between 80 ns and up. According to one example, windows are separated from each other by 100 ns, and used for data processing, regardless of window size. According to this example, no interleaving of windows is performed. The number of counting windows in one acquisition may be variable. However, in a preferred embodiment, the number of counting windows may be held to 500. As oxygen concentration decreases, lifetime increases and the counting windows are lengthened in order to acquire more of the decay signal with a fixed number of windows. An acquisition consists of pulsing the LED a number of times, for example 10,000, and transferring the total photons counted for each window for processing. Processing may include bi-exponential lifetime fitting. The electronics may also monitor the signals from a pressure sensor (Omega Engineering, PX209-015G5V) and a temperature sensor (Omega Engineering, TJ36-K-116G-6-ACL). These values may be used to adjust the reported oxygen level based on known sensor response to these two factors. FIG. 8 shows the weighted average lifetime of a bi-exponential fit as oxygen concentration is varied. Noted percentages refer to oxygen concentration for each step.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

All patents, patent applications, publications, and references cited herein are expressly incorporated by reference to the same extent as if each individual publication or patent application was specifically and individually indicated to be incorporated by reference.

What is claimed is:

1. A sensor for detecting an analyte, comprising:
an amorphous fluoropolymer; and
a metal-ligand complex, wherein said ligand comprises a macrocycle.

2. The sensor of claim 1, wherein the metal comprises a transition metal.

3. The sensor of claim 2, wherein the transition metal is selected from ruthenium, rhenium, rhodium, iridium, palladium, and platinum.

4. The sensor of claim 1, wherein the metal is platinum.

5. The sensor of claim 1, wherein the amorphous fluoropolymer comprises a copolymer formed of tetrafluoroethylene and 2,2-bis-trifluoro-methyl-4,5-difluoro-1,3-dioxol.

6. The sensor of claim 1, wherein the amorphous fluoropolymer comprises a terpolymer formed of tetrafluoroethylene, 2,2-bis(trifluoromethyl)-4,5-difluoro-1,3-dioxole and chlorotrifluoroethylene.

7. The sensor of claim 1, wherein the average pore size of the amorphous fluoropolymer is configured to selectively reduce non-analyte diffusion into the sensor.

8. The sensor of claim 1, wherein the macrocycle comprises a fluorinated macrocycle.

9. The sensor of claim 8, wherein the fluorinated macrocycle is a fluorinated porphyrin.

10. The sensor of claim 1, wherein the metal-ligand complex is platinum (II) meso-tetra (pentafluorophenylphorphine).

11. A system for measuring an analyte, comprising:
(a) a sensor comprising an amorphous fluoropolymer; and a metal-ligand complex, wherein said ligand comprises a macrocycle
(b) an excitation light source; and
(c) a detector.

12. The system of claim 11, wherein the excitation light source comprises a laser or a light emitting diode.

13. The system of claim 12, wherein the excitation light source comprises a light emitting diode.

14. The system of claim 11, wherein the excitation light source comprises a plurality of light emitting diodes.

15. The system of claim 12, wherein the laser comprises a microchip laser.

16. The system of claim 11, wherein the detector comprises a photomultiplier tube, photodiode, or an avalanche photodiode.

17. The system of claim 11, wherein the sensor is on an optically transparent substrate.

18. The system of claim 17, wherein the substrate comprises a fiber optic substrate.

19. A system for monitoring an analyte in an environment containing a volatile organic solvent, comprising an analyte sensor, the sensor comprising (i) an amorphous fluoropolymer, and (ii) a metal-ligand complex.

20. The system of claim 19, wherein the ligand comprises a fluorinated ligand.

21. The system of claim 19, wherein the ligand comprises a macrocycle.

22. The system of claim 21, wherein the macrocycle comprises a porphyrin.

23. The system of claim 22, wherein the porphyrin comprises a fluorinated porphyrin.

24. The system of claim 19, wherein the metal-ligand complex comprises platinum (II) meso-tetra (pentafluorophenylphorphine).

25. The system of claim 19, further comprising an excitation light source operably coupled to the sensor.

26. The system of claim 25, wherein the excitation light source comprises a laser or a light emitting diode.

27. The system of claim 26, wherein the excitation light source comprises a light emitting diode.

28. The system of claim 27, wherein the excitation light source comprises a plurality of light emitting diodes.

29. The system of claim 26, wherein the laser comprises a microchip laser.

30. The system of claim 19 further comprising a detector operably coupled to the sensor.

31. The system of claim 30, wherein the detector comprises a photomultiplier tube, photodiode, or an avalanche photodiode.

32. The system of claim 19, wherein the sensor is on an optically transparent substrate.

33. The system of claim 32, wherein the substrate comprises a fiber optic substrate.

34. The system of claim 19 in which the sensor is positioned in a fuel tank.

35. The system of claim 34, wherein the fuel tank is in an aircraft.

36. The system of claim 19, wherein the sensor comprises a plurality of sensors.

37. The system of claim 36, wherein the plurality of sensors comprises at least a first sensor in contact with fuel and at least a second sensor in ullage space in the fuel tank.

38. A method of producing a sensor for detecting an analyte, comprising:
swelling an amorphous fluoropolymer in a solvent in which a metal-ligand complex is dissolved; and
allowing the metal-ligand complex to penetrate the swelled amorphous fluoropolymer.

39. The method of claim 38, wherein the solvent is removed to leave the metal-ligand complex entrapped within the amorphous fluoropolymer.

40. The method of claim 39, wherein the solvent is removed by evaporation.

41. The method of claim 38, wherein the solvent is polyfluorinated and perfluorinated solvents.

42. The method of claim 38, wherein the fluorinated solvent comprises octafluorotoluene.

43. The method of claim 38 further comprising processing the sensor to reduce the average pore size of the fluoropolymer.

44. A method of detecting an analyte, comprising:
contacting a sensor comprising an amorphous fluoropolymer; and a metal-ligand complex, wherein said ligand comprises a macrocycle, and
measuring the luminescence of the metal-ligand complex.

45. The method of claim 44, wherein the measured luminescence is the luminescence intensity or lifetime changes.

46. The method of claim 45, wherein the luminescence lifetime changes is luminescence decay.

47. The method of claim 44, wherein luminescence is measured by photon-counting following pulsed excitation from a light source.

48. The method in claim 47, wherein the photon-counting is time-resolved.

49. An system for sensing oxygen, comprising:
an oxygen sensor having an amorphous fluoropolymer and a metal-ligand complex having a macrocycle ligand;
a single fiber-fiber optic probe coupled to said oxygen sensor at a first end of said fiber optic probe; and
a collimation module coupled to a second end of said single fiber-fiber optic probe, wherein said single fiber-fiber optic probe delivers excitation light and returns emission light to said collimation module.

50. The system of claim 49, further comprising at least one of a temperature and pressure sensor, wherein data from said temperature and/or pressure sensor is used to adjust oxygen sensing data due to measurement variations resulting from the temperature and/or pressure of said sensor.

51. The system of claim 49, wherein said macrocycle ligand comprises a platinum chelate (platinum (II) meso-tetra (pentafluorophenylphorphine) ligand.

52. A system for sensing an amount of air comprising:
(a) an oxygen sensor comprising an amorphous fluoropolymer; and a metal-ligand complex, wherein said ligand comprises a macrocycle
(b) an excitation light source;
(c) a detector; and
(d) a processor, wherein said processor calculates the amount of air present based on the detected oxygen.

53. The system of claim 52, wherein the sensor comprises a plurality of sensors.

54. The system of claim 53, wherein the plurality of sensors comprises at least a first sensor in contact with a fluid having dissolved air and at least a second sensor in contact with free air.

55. The system of claim 54, wherein the fluid comprises hydraulic fluid.

56. The system of claim 52, wherein the oxygen sensor is in contact with a fluid.

57. The system of claim 56, wherein the fluid comprises hydraulic fluid.

58. The system of claim 52, wherein the oxygen sensor is in contact with free air.
